(19) United States
(12) Patent Application Publication
(10) Pub. No.: US 2019/0303102 A1
(43) Pub. Date: Oct. 3, 2019

(54) OUTPUT VALUE GENERATOR CIRCUIT, PROCESSOR, OUTPUT VALUE GENERATION METHOD AND NON-TRANSITORY COMPUTER READABLE MEDIUM

(71) Applicant: PANASONIC INTELLECTUAL PROPERTY MANAGEMENT CO., LTD., Osaka (JP)

(72) Inventors: Norifumi MURATA, Kyoto (JP); Kyoko UEDA, Osaka (JP)

(73) Assignee: PANASONIC INTELLECTUAL PROPERTY MANAGEMENT CO., LTD., Osaka (JP)

(21) Appl. No.: 16/365,060

(22) Filed: Mar. 26, 2019

(30) Foreign Application Priority Data
Mar. 29, 2018 (JP) 2018-063912

(51) Int. Cl. G06F 7/487; G06F 7/499; G06F 7/548

(52) U.S. Cl. CPC G06F 7/4876; G06F 7/548; G06F 7/49915

(57) ABSTRACT

An output value generator circuit possesses an output unit (reciprocal output unit) configured to generate a mantissa and a characteristic of an output value in floating-point representation, and individually output the mantissa and the characteristic. The output value is obtained by conversion of an input value.

### CROSS REFERENCE TO RELATED APPLICATION

This application claims the benefit and priority of Japanese Patent Application No. 2018-063912, filed on Mar. 29, 2018, the entire contents of which is incorporated herein by reference.

### TECHNICAL FIELD

The disclosure relates to output value generator circuits, processors, output value generation methods and non-transitory computer readable media. The disclosure relates, more particularly, to an output value generator circuit, a processor, an output value generation method and a non-transitory computer readable medium, for converting an input value to generate an output value.

### BACKGROUND ART

There has been provided a table reading circuit configured to, when receiving an integer as an input value, read a reciprocal of the integer from a table to output the reciprocal (e.g., see JP H01-263812 A (hereinafter referred to as “Document 1”)).

The table reading circuit disclosed in Document 1 has an issue that a fixed-point number is outputted, and thereby an integer value as the input value becoming larger causes more reduction of precision of a corresponding output value.

### SUMMARY

It is an object of the present disclosure to provide an output value generator circuit, a processor, an output value generation method and a non-transitory computer readable medium, capable of preventing precision of an output value from reducing.

An output value generator circuit according to an aspect of the disclosure possesses an output unit. The output unit is configured to generate a mantissa and a characteristic of an output value in floating-point representation to individually output the mantissa and the characteristic. The output value is obtained by conversion of an input value.

A processor according to an aspect of the disclosure includes the output value generator circuit and a control circuit. The control circuit is configured to cause the output value generator circuit to, when receiving an input value, operate according to an operation instruction to generate a mantissa and a characteristic of an output value in floating-point representation, and individually output the mantissa and the characteristic. The output value is obtained by conversion of an input value.

An output value generation method according to an aspect of the disclosure includes generating a mantissa and a characteristic of an output value in floating-point representation and individually outputting the mantissa and the characteristic. The output value is obtained by conversion of an input value.

A non-transitory computer readable medium according to an aspect of the disclosure, includes instructions stored thereon, that when executed on a processor, perform, as an output process, the steps of; generating a mantissa and a characteristic of an output value in floating-point representation; and individually outputting the mantissa and the characteristic. The output value is obtained by conversion of an input value.

### BRIEF DESCRIPTION OF THE DRAWINGS

FIG. 1 is a block diagram of a processor including an output value generator circuit according to an embodiment of the present disclosure.

FIG. 2 is a block diagram of the output value generator circuit.

FIG. 3A illustrates an address generating process by the output value generator circuit.

FIG. 3B illustrates an address generating process by the output value generator circuit.

FIG. 3C illustrates an address generating process by the output value generator circuit.

FIG. 4 is a flow chart illustrating an operation of the output value generator circuit.

### DETAILED DESCRIPTION

### Embodiment

### (1) Schema

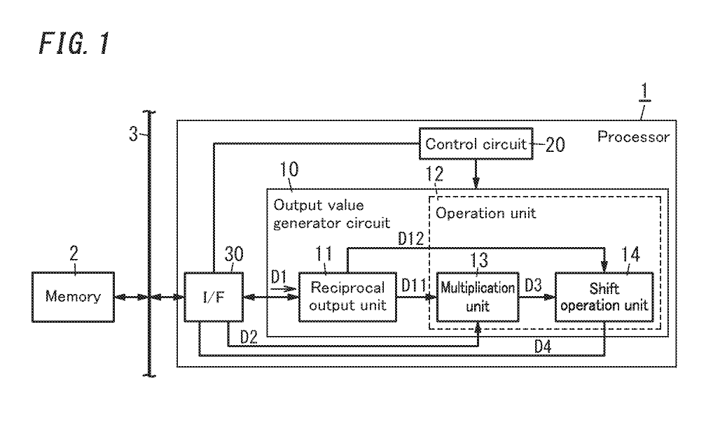

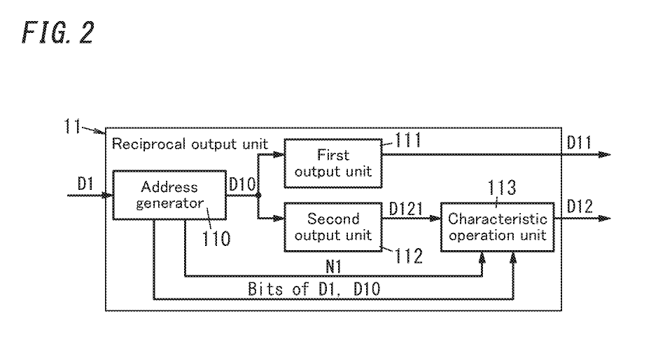

As shown in FIG. 1, an output value generator circuit 10 according to the present embodiment possesses an output unit (a reciprocal output unit 11). As shown in FIG. 2, the output unit (reciprocal output unit 11) is configured to generate a mantissa D11 and a characteristic D12 of an output value in floating-point representation to individually output the mantissa D11 and the characteristic D12. The output value is obtained by conversion of an input value. Here, the output value is expressed in floating-point representation or format.

A processor 1 according to the embodiment includes the output value generator circuit 10. The processor 1 is configured to cause the output value generator circuit 10 to, when receiving the input value D1, individually output the mantissa D11 and the characteristic D12.

Herein, examples of obtaining the output value by conversion of the input value D1 include converting the input value D1 into the output value based on a function representing a relationship between input values D1 and respective output values. Examples of the function representing the relationship between the input values D1 and the respective output values include a function that outputs a reciprocal of an input value, a function that outputs a square root of an input value, a function that outputs a reciprocal of a square root of an input value, trigonometric functions, inverse trigonometric functions, and the like. The output value needn't be exactly the same as a value obtained by converting an input value through a predetermined function, but may be an approximate value in a range obtained by approximating a value converted from an input value through the predetermined function in a tolerance range (e.g., −0.1% or more and 0.1% or less).

The embodiment enables the output value generator circuit 10 and the processor 1 to individually output a mantissa D11 and a characteristic D12 of an output value in floating-point representation without a floating-point arithmetic unit. The output value is obtained by conversion of an input value. Since the output value generator circuit 10 individually outputs the mantissa D11 and the characteristic D12 of the output value in floating-point representation, it is possible to obtain output precision according to the number of digits of the mantissa D11 and to prevent precision of the output value from reducing.

### (2) Details

Application examples of the output value generator circuit 10 according to the embodiment include an arithmetic process in image processing on digital images captured by a camera, and the like. Image processing for detecting objects such as persons and lanes from digital images from vehicle cameras may contains, for example a filtering technique such as a differential filter on digital images, for detecting features such as edge patterns and tones of color from digital images. The filtering technique may include an (arithmetic) operation in which a value of each pixel (each pixel value) of the digital images is divided by a predetermined value. The output value generator circuit 10 according to the embodiment is used for such a division operation. That is, when performing an (arithmetic) operation according to a division instruction to divide a number (dividend) by a divisor to obtain a number (quotient), the output value generator circuit 10 performs an alternative operation instead of the division operation in which the dividend is divided by the divisor. That is, the output value generator circuit 10 is configured to calculate a reciprocal of the divisor to multiply the reciprocal of the divisor by the dividend, thereby working out a value as the quotient obtained by dividing the dividend by the divisor. Similarly, when performing an (arithmetic) operation according to a division instruction to divide a value of each pixel (i.e., each pixel value) of the digital images by the same value (divisor), the output value generator circuit 10 is to first calculate a reciprocal of the divisor and then multiply the reciprocal by each pixel value, thereby working out a value as a quotient obtained by dividing each pixel value by the divisor. Thus, in order to work out a value as a quotient obtained by dividing each pixel value by the divisor, only one operation in which a reciprocal of the divisor is calculated enables reduction of a processing cost in the arithmetic process.

The output value generator circuit 10 according to the embodiment and the processor 1 including the output value generator circuit 10 will hereinafter be explained.

(2.1) Configuration

As shown in FIG. 1, the processor 1 includes the output value generator circuit 10, a control circuit 20 and an interface (I/F) 30.

The interface (I/F) 30 allows the output value generator circuit 10 and the control circuit 20 to write and read data to and from a memory 2 via a bus 3.

The memory 2 is configured to store a program (e.g., program for image processing) to be executed by the processor 1. The memory 2 may store a mantissa D11 and a characteristic D121 of a reciprocal, of an intermediate operation value D10 generated from the input value D1, in floating-point representation. The reciprocal of the intermediate operation value D10 is obtained as a floating-point arithmetic result of the reciprocal of the intermediate operation value D10 (see FIG. 2). The intermediate operation value D10 is, for example an integer in a range of 0 to 255. In a specific example, the memory 2 stores a mantissa table and a characteristic table. The mantissa table contains a collection of data (data set), each of which contains, for each of different input values D1, an address determined based on an intermediate operation value D10 generated and a corresponding mantissa D11. Here, the number of bits of the address is, for example the same as that of the intermediate operation value D10 (e.g., 8 bits). The characteristic table contains a collection of data (data set), each of which contains, for each of the different input values D1, an address determined based on an intermediate operation value D10 generated and a corresponding characteristic D121. Here, the number of bits of the address is, for example the same as that of the intermediate operation value D10 (e.g., 8 bits).

The control circuit 20 is configured to acquire an operation instruction (command) from the memory 2 via the interface 30 to control a process by the output value generator circuit 10 according to the operation instruction.

The output value generator circuit 10 is configured to generate a mantissa D11 and a characteristic D12 of an output value in floating-point representation to individually output the mantissa D11 and the characteristic D12. The output value is obtained by conversion of an input value. Here, a relationship between input values D1 and respective output values is represented by a predetermined function. In the present embodiment, the predetermined function is a function that outputs a reciprocal of the input value D1, and the output value is therefore a reciprocal of the input value D1.

The output value generator circuit 10 includes a reciprocal output unit 11 and an operation unit 12.

The reciprocal output unit 11 is configured to generate a mantissa D11 and a characteristic D12 of an output value in floating-point representation to individually output the mantissa D11 and the characteristic D12. The output value is a reciprocal of an input value D1. As shown in FIG. 2, the reciprocal output unit 11 includes an address generator 110, a first output unit 111, a second output unit 112 and a characteristic operation unit 113.

The address generator 110 is configured to determine respective addresses referring to the characteristic table and the mantissa table based on the input value D1. Specifically, the address generator 110 generates an address of the mantissa table in which a mantissa D11 of a reciprocal of an intermediate operation value D10 generated based on the input value D1 is stored. The address generator 110 also generates an address of the characteristic table in which a characteristic D121 of the reciprocal of the intermediate operation value D10 generated based on the input value D1 is stored.

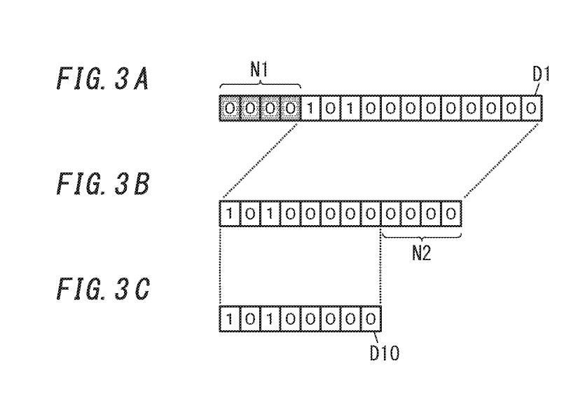

Here, an address generating process by the address generator 110 will be explained with reference to FIGS. 3A to 3C. When the reciprocal output unit 11 receives, for example an input value D1 of 16-bit as shown in FIG. 3A, the address generator 110 counts the number (N1) of “0”s consecutive from the most significant bit of the input value D1. In the example of FIG. 3A, four “0”s are consecutive from the most significant bit of the input value D1. The address generator 110 counts the number N1 (e.g., 4) of “0”s consecutive from the most significant bit. The address generator 110 performs a digit (e.g., bit) shift such as a left shift (e.g., arithmetic left shift) to shift the input value D1 to the left by the number (N1) of bit (digit) positions to shift out (discard) the “0”s (see FIG. 3B), thereby working out an intermediate operation value D10 that is the most significant 8 bits of data (see FIG. 3C). Here, the number of bits (digits) of the intermediate operation value D10 is, for example, determined in advance, or determined by the number of bits (digits) of the mantissa D11 of the output value (e.g., 8 bits) specified by a division instruction. However, the embodiment is not limited to this, but the number of bits of the intermediate operation value D10 may be specified by the division instruction because the number of bits of the intermediate operation value D10 is the same as the number of bits of the mantissa D11. In other words, the address generator 110 shifts the input value D1 to the left by the number (N1) of bit positions to discard the “0” s, and then performs a digit (e.g., bit) shift such as a right shift (e.g., arithmetic right shift) to shift the remaining bits to the right by the number (N2) of bit (digit) positions in order to generate the intermediate operation value D10 of 8 bits. The address generator 110 defines the intermediate operation value D10 of eight bits as a common address referring to each of the mantissa and characteristic tables, and provides each of the first and second output units 111 and 112 with a value of the intermediate operation value D10 as data containing the address. Thus, the address generator 110 generates the intermediate operation value D10 of 8 bits from the input value D1 of 16 bits, and defines the intermediate operation value D10 as the common address referring to each of the mantissa and characteristic tables. It is therefore possible to reduce the data volume of the mantissa and characteristic tables respectively containing the mantissas D11 and the characteristics D12 more than the data volume of mantissa and characteristic tables respectively containing mantissas and characteristics allocated to the different input values D1 as their respective addresses (16-bit address). Note that in the embodiment, the input value D1 is a positive integer of 16 bits, but may be a positive integer of 8 bits or 32 bits, or may be appropriately changed according to contents of the operation process. In the embodiment, the intermediate operation value D10 is a positive integer of 8 bits, but not limited to the positive integer of 8 bits as long as it is an integer whose bit-length is less than that of the input value D1.

The first output unit 111 is configured to access the mantissa table in the memory 2 according to the address generated by the address generator 110, acquire (generate) the mantissa D11 of the reciprocal of the intermediate operation value D10, and store a value of the generated mantissa D11 in a stack memory. The stack memory is realized by, for example a stack area of the memory 2. Thus, the first output unit 111 (reciprocal output unit 11) generates (outputs) the mantissa D11 based on a value (D11) allocated to the address determined from the input value D1. Specifically, the first output unit 111 reads the corresponding mantissa D11 from the mantissa table based on the address generated by the address generator 110 to generate (output) the mantissa D11.

The second output unit 112 is configured to access the characteristic table in the memory 2 according to the address generated by the address generator 110, acquire (generate) the characteristic D121 of the reciprocal of the intermediate operation value D10, and provide the generated characteristic D121 to the characteristic operation unit 113.

The characteristic operation unit 113 is configured to receive the characteristic D121 from the second output unit 112. The characteristic operation unit 113 also receives, from the address generator 110, data containing the number of bits of (length of bits of) the input value D1 and the number of bits of the intermediate operation value D10 (in the embodiment, e.g., 8 bits), and data containing the number N1. Based on the data containing the input value D1 and the number of bits of the intermediate operation value D10, and data containing the number N1, the characteristic operation unit 113 works out the number (N2) of bit positions for the right shift of the intermediate operation value D10. The characteristic operation unit 113 subtracts the number N1 and the number of bits of the intermediate operation value D10 from the number of bits of the input value D1, thereby working out the number (N2) of bit positions for the right shift. The characteristic operation unit 113 then subtracts the number (N2) of bit positions for the right shift from the characteristic D121 received from the second output unit 112 to work out the characteristic D12 of the reciprocal of the input value (1/D1) in floating-point representation, and store a value of the characteristic D12 in the stack memory.

That is, the second output unit 112 and the characteristic operation unit 113 constituting the reciprocal output unit 11 generates (outputs) the characteristic D12 based on a value (D121) allocated to the address determined from the input value D1. Moreover, in the embodiment, the address generator 110 determines the address based on the intermediate operation value D10 obtained by a shift operation such as bit shift (e.g., left shift) of the input value D1. The characteristic D12 is then determined based on the number (N2) of bit positions for the right shift of the intermediate operation value D10 and the characteristic D121 of the intermediate operation value D10 in floating-point representation. In other words, based on the address generated by the address generator 110, the reciprocal output unit 11 reads the corresponding characteristic D121 from the characteristic table. The reciprocal output unit 11 also calculates the number (N2) of bit positions for the right shift based on the number of bits of the input value D1, the number of bits of the intermediate operation value D10, and the number N1. The reciprocal output unit 11 then works out the characteristic D12 by subtracting the number (N2) of bit positions for the right shift from the characteristic D121. Thus, the reciprocal output unit 11 generates (outputs) the characteristic D12 based on the address generated by the address generator 110.

Here, by using the intermediate operation value D10 and the number (N2) of bit positions for the right shift of the intermediate operation value D10, the input value D1 is represented by Expression 1, as below:

D1≅D10×2^{N2} (Expression 1).

In addition, by using the mantissa D11, the characteristic D121 and the characteristic D12, the reciprocal of the input value D1 is represented by Expression 2, as follow:

$$\frac{1}{D 1} ≅ \frac{1}{D 10 \times {2}^{N 2}} = D 11 \times {2}^{D 121 - N 2} = D 11 \times {2}^{D 12} . \qquad ( Expression 2 )$$

The operation unit 12 will next be explained. The operation unit 12 is configured to perform an operation process based on respective values of the mantissa D11 and the characteristic D12 read from the stack memory, and the dividend D2 received from the memory 2 via the interface 30 to work out a value D4 as a quotient obtained by dividing the dividend D2 by the input value D1 that is a divisor. That is, the output value generator circuit 10 further includes the operation unit 12 configured to perform the operation process based on both the mantissa D11 and the characteristic D12.

The operation unit 12 includes a multiplication unit 13 and a shift operation unit 14.

The multiplication unit 13 is configured to multiply the mantissa D11 and the dividend D2 read from the stack memory to obtain a multiplication result (product) D3 and provide the multiplication result D3 to the shift operation unit 14.

The shift operation unit 14 is configured to perform a bit shift (e.g., left shift) to shift the multiplication result D3 provided from the multiplication unit 13 by the number of bit positions according to the characteristic D12 (e.g., the number of bits (digits) of characteristic D12) read from the stack memory, thereby working out the value D4 as the quotient obtained by dividing the dividend D2 by the input value D1 that is the divisor. The shift operation unit 14 is to store the value D4 as the operation result in the memory 2 or the like via the interface 30. Here, by using the dividend D2, the mantissa D11 and the characteristic D12, the value D4 is represented by Expression 3, as follow:

$$D 4 = \frac{D 2}{D 1} ≅ D 2 \times D 11 \times {2}^{D 12} . \qquad ( Expression 3 )$$

(2.2) Operation

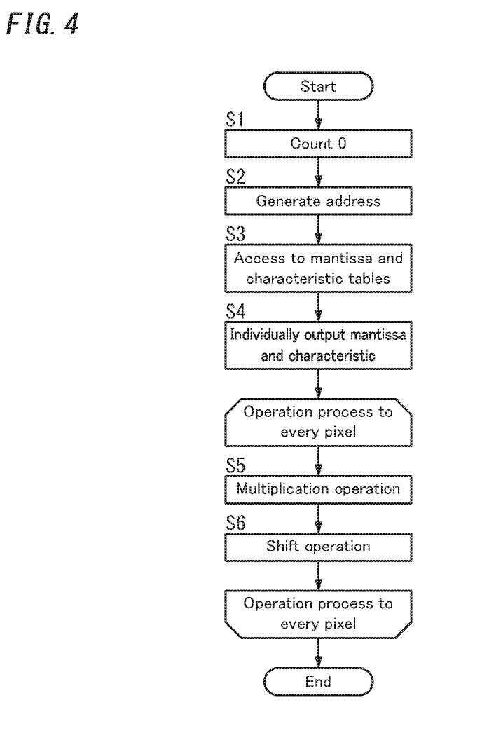

A process performed by the processor 1 according to the program stored in the memory 2 will be explained with reference to FIG. 4. Here, the processor 1 performs an (arithmetic) operation according to a division instruction to work out a quotient by dividing the dividend D2 by the input value D1 that is the divisor. In the process to be explained here, the processor 1 performs an operation according to a division instruction to divide dividends D2 by the same value (input value D1) to work out respective quotients.

The control circuit 20 in the processor 1 activates according to the division instruction installed in the processor 1, and then causes the output value generator circuit 10 to perform a process of steps S1 to S6.

First, the address generator 110 in the reciprocal output unit 11 counts the number (N1) of “0”s consecutive from the most significant bit of the input value D1 (S1).

The address generator 110 performs the left shift to shift the input value D1 to the left by the number (N1) of bit positions to discard the “0” s, and then performs the right shift to shift the remaining bits to the right by the number (N2) of bit positions, thereby generating the intermediate operation value D10 of 8 bits. Based on this intermediate operation value D10, the address generator 110 then generates the common address that allows access to the mantissa and characteristic tables (S2). The address generator 110 provides the first output unit 111 with the value itself of the intermediate operation value D10 as the address that allows access to the mantissa table, and also provides the second output unit 112 with the value itself of the intermediate operation value D10 as the address that allows access to the characteristic table. Note that in the present embodiment, the address that allows access to the mantissa table is the same as the address that allows access to the characteristic table, but may be different from the address that allows access to the characteristic table.

When receiving the address from the address generator 110, the first output unit 111 accesses the mantissa table based on the address, and generates the mantissa D11 of the intermediate operation value D10 in floating-point representation. In addition, when receiving the address from the address generator 110, the second output unit 112 accesses the characteristic table based on the address, and generates the characteristic D121 of the intermediate operation value D10 in floating-point representation (S3).

The first output unit 111 provides the generated mantissa D11 to the stack memory. The second output unit 112 provides the generated characteristic D121 to the characteristic operation unit 113. The characteristic operation unit 113 works out the number (N2) of bit positions for the right shift based on the number N1 provided from the address generator 110, and subtracts the number (N2) of bit positions for the right shift from the characteristic D121 provided from the second output unit 112 to work out the characteristic D12. That is, the characteristic D12 of the reciprocal, of the input value D1, in floating-point representation is determined based on the number of bit positions for the right shift, N2 by which the input value D1 is shifted in order to obtain the intermediate operation value D10, and the characteristic D121 of the intermediate operation value D10 in floating-point representation. The characteristic operation unit 113 stores, in the stack memory, the characteristic D12 determined based on the number of bit positions for the right shift, N2, and the characteristic D121. Thus, the reciprocal output unit 11 individually outputs the mantissa D11 and the characteristic D12 (S4).

Subsequently, the operation unit 12 repeatedly performs a (sub-)process of steps S5 and S6 to work out respective values as quotients obtained by dividing the dividends D2 by the same value (input value D1) based on the mantissa D11 and the characteristic D12 stored in the stack memory.

At Step S5, the multiplication unit 13 multiplies the mantissa D11 by the dividend D2. At step S6, the shift operation unit 14 performs a shift (e.g., left shift) operation such as a bit shift to shift the multiplication result D3 by the multiplication unit 13 based on the characteristic D12, thereby working out the value D4 as the quotient obtained by dividing the dividend D2 by the input value D1 that is the divisor.

When the process of steps S5 and S6 has been performed with respect to the dividends D2, the processor 1 finishes the process according to the division instruction to work out the respective quotients by dividing the dividends D2 by the input value D1.

Thus, when operating according to the division instruction to divide the dividend D2 by the input value D1 that is the divisor, the processor 1 according to the embodiment finds the mantissa D11 and the characteristic D12 of the reciprocal, of the input value D1 as the divisor, in the floating-point representation. The reciprocal output unit 11 in the processor 1 finds the mantissa D11 and the characteristic D12 of the reciprocal (output value), of the input value D1, in the floating-point representation to individually output the mantissa D11 and the characteristic D12. It is therefore possible to obtain an output (value) having precision according to bits (bit-length) of the mantissa D11, thereby preventing the precision of the output value from reducing and enabling a subsequent operation process (e.g., division process) without a floating-point arithmetic unit. Based on the mantissa D11 and the characteristic D12, the processor 1 works out the value as the quotient obtained by dividing the dividend D2 by the input value D1. Thus, finding the mantissa D11 and the characteristic D12 of the reciprocal, of the input value D1, in floating-point representation to store the mantissa D11 and the characteristic D12 in the stack memory or the like enables an operation process according to an instruction to perform divisions based on the mantissa D11 and the characteristic D12. Therefore, in comparison with the division operations in which the dividends D2 are divided by the same input value D1, it is possible to reduce a processing cost in the arithmetic processing.

### (3) Modified Examples

The above embodiment is merely one of various embodiments of the present disclosure. In the embodiment, various modifications are possible in light of general arrangement and the like as long as the object of the disclosure is achieved. A function that is similar to the output value generator circuit 10 may be embodied in an output value generation method, a computer program or a non-transitory computer readable medium storing the program. An output value generation method according to an aspect includes generating a mantissa D11 and a characteristic D12 of an output value in floating-point representation, and individually outputting the mantissa D11 and the characteristic D12. Here, the output value is obtained by conversion of an input value D1. A (computer) program according to an aspect includes instructions which, when the program is executed by a computer system, cause the computer system to carry out, as an output process, generating a mantissa D11 and a characteristic D12 of an output value in floating-point representation, and individually outputting the mantissa D11 and the characteristic D12. Here, the output value is obtained by conversion of an input value D1. In one example, the program includes instructions or an instruction set to be installed in the processor 1 to cause the processor 1 to carry out an arithmetic process such as a division process. A processor according to an aspect includes an output value generator circuit 10, and executes a program installed thereon, thereby causing the output value generator circuit 10 to, when receiving an input value D1, generate a mantissa D11 and a characteristic D12 of an output value in floating-point representation to individually output the mantissa D11 and the characteristic D12. Here, the output value is obtained by conversion of an input value D1.

Modified examples of the above embodiment will be described below. The modified examples to be explained below may be appropriately combined.

An executing entity according to each of the output value generator circuit 10 and the output value generation method in the disclosure may include a computer system. The computer system is mainly composed of a processor and a memory as hardware. The processor executes a program stored in the memory of the computer system, thereby realizing functions as the executing entity according to each of the output value generator circuit 10 and the output value generation method in the disclosure. The program may not only be stored in the memory of the computer system in advance, but also be provided via a telecommunications network or via a non-transitory computer readable medium storing the program. Examples of the non-transitory computer readable medium include a memory card, an optical disk, a hard disc drive and the like. Configuration examples of the processor of the computer system include one electronic circuit, and two or more electronic circuits. Component examples of the one or more electronic circuits include one and more semiconductor integrated circuits (ICs) and one and more large scale integrated circuits (LSIs). The two or more electronic circuits may be packaged in one chip together, or packaged in two or more chips in a dispersed manner. The two or more chips may be put in one device together, or be put in two or more devices in a dispersed manner.

In the above embodiment, the output value generator circuit 10 includes the output unit (reciprocal output unit 11) configured to output the mantissa D11 and the characteristic D12 of the output value in floating-point representation. Here, the output value is the reciprocal of the input value D1. However, the output unit is not limited to the configuration in which the reciprocal of the input value D1 is outputted. A relationship between input values D1 and their respective output values may be represented by a predetermined function. Examples of the function include a function that outputs a square root of the input value D1, a function that outputs a reciprocal of a square root of the input value D1, trigonometric functions, inverse trigonometric functions, and the like.

In the above embodiment, the output value generator circuit 10 includes the operation unit 12 configured to perform a predetermined operation process based on the mantissa D11 and the characteristic D12 outputted from the output value generator circuit 10. However, the operation unit 12 may be provided outside the reciprocal output unit 11. In this case, the mantissa D11 and the characteristic D12 outputted from the reciprocal output unit 11 may be stored in the stack memory or the like. The operation unit 12 may read the mantissa D11 and the characteristic D12 from the stack memory or the like to perform a subsequent operation process.

In the above embodiment, the memory 2 stores the mantissa and characteristic tables, but an internal memory of the processor 1 may store the mantissa and characteristic tables.

According to the address determined based on the input value D1, the output value generator circuit 10 generates a mantissa D11 from the mantissa table and generates a characteristic D12 from the characteristic table, but the mantissa and characteristic tables are not essential. That is, the mantissa table is not essential as long as the address determined based on the input value D1 and the mantissa D11 are associated with each other and stored in the memory 2 or the internal memory. Similarly, the characteristic table is not essential as long as the address determined based on the input value D1 and the characteristic D12 are associated with each other and stored in the memory 2 or the internal memory.

The second output unit 112 obtains, from the characteristic table, a characteristic D12 of the intermediate operation value D10 in floating-point representation, but the characteristic D12 may be obtained by calculation.

The output value generator circuit 10 associates the mantissa D11 and the characteristic D12 with the address determined based on the intermediate operation value D10 obtained by the shift operation such as the bit shift (e.g., left shift) of the input value D1, and stores the mantissa D11 and the characteristic D12 in the memory 2. The number of mantissas D11 and characteristics D12 stored in the memory 2 is less than the number of input values D1. Thus, the capacity of the memory 2 can be reduced, but generating the intermediate operation value D10 is not essential. That is, the memory 2 or the internal memory may store the mantissa table including data of the mantissa D11 of the input data D1 in floating-point representation in an address with the input data D1 rendered as the address. Similarly, the memory 2 or the internal memory may store the mantissa table including data of the characteristic D12 of the input data D1 in floating-point representation in an address with the input data D1 rendered as the address. In this case, the address generator 110 is unnecessary. The first output unit 111 may obtain the mantissa D11 from the mantissa table with the input data D1 rendered as the address. The second output unit 112 may obtain the characteristic D12 from the characteristic table with the input data D1 rendered as the address.

(Brief)

As explained above, an output value generator circuit (10) according to a first aspect possesses an output unit (11). The output unit (11) is configured to generate a mantissa (D11) and a characteristic (D12) of an output value in floating-point representation to individually output the mantissa (D11) and the characteristic (D12). The output value is obtained by conversion of an input value (D1).

In this aspect, the mantissa (D11) and the characteristic (D12) are individually outputted, thereby enabling preventing precision of the output value from reducing, and enabling even a circuit or a processor without a floating-point arithmetic unit to perform a subsequent process.

In an output value generator circuit (10) according to a second aspect turning on the first aspect, a relationship between input values (D1) and their respective outputs is represented by a predetermined function.

This aspect enables preventing precision of each of the output values from reducing.

In an output value generator circuit (10) according to a third aspect turning on the first aspect, the output value is a reciprocal of the input value (D1).

This aspect enables precision of the output value from reducing.

In an output value generator circuit (10) according to a fourth aspect turning on the first to third aspects, the output unit (11) is configured to generate the mantissa (D11) based on a value allocated to an address determined from the input value (D1).

This aspect doesn't need calculate the mantissa (D11) each time, thereby enabling reduction of cost in the arithmetic processing.

In an output value generator circuit (10) according to a fifth aspect turning on the first to third aspects, the output unit (11) is configured to generate the characteristic (D12) based on a value allocated to an address determined from the input value (D1).

This aspect doesn't need calculate the characteristic (D12) each time, thereby enabling reduction of cost in the arithmetic processing.

In an output value generator circuit (10) according to a sixth aspect turning on the fifth aspect, the address is determined based on an intermediate operation value (D10) obtained by a shift operation (such as a bit shift (e.g., left shift) of the input value (D1). The output value generator circuit (10) is configured to determine the characteristic (D12) based on a number of bit positions, (N2) by which the input value (D1) is shifted to obtain the intermediate operation value (D10), and a characteristic (D121) of the intermediate operation value (D10) in floating-point representation.

This aspect enables more reduction in the number of characteristics (D121) of the intermediate operation value (D10) to be stored than that of a configuration in which the input value (D1) itself is rendered as the address, thereby enabling reduction in the capacity of a memory required for storing characteristics (D121).

An output value generator circuit (10) according to a seventh aspect turning on the first to sixth aspects further includes an operation unit (12) configured to perform an operation process based on both the mantissa (D11) and the characteristic (D12) of the output value.

This aspect enables preventing precision of the output value from reducing.

In an output value generator circuit (10) according to an eighth aspect turning on the first to seventh aspects, the operation unit (12) is configured to multiply a number by the mantissa (D11) of the output value that is a reciprocal of the input value (D1) to obtain a multiplication result, and shift the multiplication result by a number of bit positions corresponding to the characteristic (D12) of the output value, thereby performing an operation to work out a value as a quotient obtained by dividing the number by the input value (D1).

This aspect enables preventing precision of the output value from reducing.

In an output value generator circuit (10) according to a ninth aspect turning on the eighth aspect, the operation unit (12) is configured to multiply each of numbers by the mantissa (D11) to obtain respective multiplication results, and shift each of the respective multiplication results by the number of bit positions corresponding to the characteristic (D12) of the output value, thereby performing operations to work out respective values as quotients obtained by dividing the numbers by the same input value (D1).

This aspect enables preventing precision of each of the output values from reducing.

A processor (1) according to a tenth aspect includes the output value generator circuit (10) according to a first aspect, and a control circuit (20). The control circuit (20) is configured to cause the output value generator circuit (10) to, when receiving the input value (D1), operate according to an operation instruction to generate a mantissa (D11) and a characteristic (D12) of an output value in floating-point representation, and individually output the mantissa (D11) and the characteristic (D12). The output value is obtained by conversion of an input value (D1).

This aspect enables preventing precision of the output value from reducing, and enables even a circuit or a processor without a floating-point arithmetic unit to perform a subsequent process.

An output value generation method according to an eleventh aspect includes generating a mantissa (D11) and a characteristic (D12) of an output value in floating-point representation, and individually outputting the mantissa (D11) and the characteristic (D12). The output value is obtained by conversion of an input value (D1).

This aspect enables preventing precision of the output value from reducing, and enables even a circuit or a processor without a floating-point arithmetic unit to perform a subsequent process.

A non-transitory computer readable medium according to a twelfth aspect includes instructions stored thereon, that when executed on a processor, perform, as an output process, the steps of: generating a mantissa (D11) and a characteristic (D12) of an output value in floating-point representation; and individually outputting the mantissa (D11) and the characteristic (D12). The output value is obtained by conversion of an input value (D1).

This aspect enables preventing precision of the output value from reducing, and enables even a circuit or a processor without a floating-point arithmetic unit to perform a subsequent process.

Besides the above aspects, various configurations (including the modified examples) of the output value generator circuit (10) according to the above embodiment may be embodied in the output value generation method, the processor including the output value generator circuit (10), the (computer) program, and the non-transitory computer readable medium storing the program.

Respective configurations of the second to ninth aspects may be appropriately omitted, and are not essential for the output value generator circuit (10).

1. An output value generator circuit, comprising an output unit configured to:
generate a mantissa and a characteristic of an output value in floating-point representation, the output value being obtained by conversion of an input value; and
individually output the mantissa and the characteristic.

2. The output value generator circuit of claim 1, wherein a relationship between input values and their respective outputs is represented by a predetermined function.

3. The output value generator circuit of claim 1, wherein the output value is a reciprocal of the input value.

4. The output value generator circuit of claim 1, wherein the output unit is configured to generate the mantissa based on a value allocated to an address determined from the input value.

5. The output value generator circuit of claim 2, wherein the output unit is configured to generate the mantissa based on a value allocated to an address determined from the input value.

6. The output value generator circuit of claim 3, wherein the output unit is configured to generate the mantissa based on a value allocated to an address determined from the input value.

7. The output value generator circuit of claim 1, wherein the output unit is configured to generate the characteristic based on a value allocated to an address determined from the input value.

8. The output value generator circuit of claim 2, wherein the output unit is configured to generate the characteristic based on a value allocated to an address determined from on the input value.

9. The output value generator circuit of claim 3, wherein the output unit is configured to generate the characteristic based on a value allocated to an address determined from on the input value.

10. The output value generator circuit of claim 7, wherein
the address is determined based on an intermediate operation value obtained by a shift operation of the input value,
the output value generator circuit is configured to determine the characteristic based on a number of digit positions by which the input value is shifted to obtain the intermediate operation value, and a characteristic of the intermediate operation value in floating-point representation.

11. The output value generator circuit of claim 1, further comprising an operation unit configured to perform an operation process based on both the mantissa and the characteristic of the output value.

12. The output value generator circuit of claim 11, wherein the operation unit is configured to multiply a number by the mantissa of the output value that is a reciprocal of the input value to obtain a multiplication result, and shift the multiplication result by a number of digit positions corresponding to the characteristic of the output value, thereby performing an operation to work out a value as a quotient obtained by dividing the number by the input value.

13. The output value generator circuit of claim 12, wherein the operation unit is configured to multiply each of numbers by the mantissa to obtain respective multiplication results, and shift each of the respective multiplication results by the number of digit positions corresponding to the characteristic of the output value, thereby performing operations to work out respective values as quotients obtained by dividing the numbers by the same input value.

14. A processor, comprising
the output value generator circuit of claim 1, and
a control circuit that is configured to cause the output value generator circuit to, when receiving an input value, operate according to an operation instruction to
generate a mantissa and a characteristic of an output value in floating-point representation, the output value being obtained by conversion of the input value, and
individually output the mantissa and the characteristic.

15. The processor of claim 14, wherein a relationship between input values and their respective outputs is represented by a predetermined function.

16. The processor of claim 14, wherein the output value is a reciprocal of the input value.

17. The processor of claim 14, wherein
the output value generator circuit further comprises an operation unit configured to perform an operation process based on both the mantissa and the characteristic of the output value.
the operation unit is configured to
multiply a number by the mantissa of the output value that is a reciprocal of the input value to obtain a multiplication result, and
shift the multiplication result by a number of digit positions corresponding to the characteristic of the output value,
thereby performing an operation to work out a value as a quotient obtained by dividing the number by the input value.

18. The processor of claim 17, wherein the operation unit is configured to
multiply each of numbers by the mantissa to obtain respective multiplication results, and
shift each of the respective multiplication results by the number of digit positions corresponding to the characteristic of the output value,
thereby performing operations to work out respective values as quotients obtained by dividing the numbers by the same input value.

19. An output value generation method, comprising:
generating a mantissa and a characteristic of an output value in floating-point representation, the output value being obtained by conversion of an input value; and
individually outputting the mantissa and the characteristic.

20. A non-transitory computer readable medium, comprising instructions stored thereon, that when executed on a processor, perform, as an output process, the steps of:
generating a mantissa and a characteristic of an output value in floating-point representation, the output value being obtained by conversion of an input value; and
individually outputting the mantissa and the characteristic.
